(19) United States
(12) Patent Application Publication
(10) Pub. No.: US 2006/0168485 A1
(43) Pub. Date: Jul. 27, 2006

(54) Updating instruction fault status register

(75) Inventors: Zihno Jusufovic, Arlington, TX (US); William V. Miller, Arlington, TX (US); Tim Short, Duncanville, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc

(21) Appl. No.: 11/043,701

(22) Filed: Jan. 26, 2005

(51) Int. Cl. G06F 11/00

(52) U.S. Cl. 714/49

(57) ABSTRACT

In a pipeline architecture, an instruction fault status register (FSR) is used to save the reason for a fault between the time an instruction is fetched and when it is executed. Sequential faults for different reasons cause an overwrite of the FSR and invalid abort codes upon the execution of an instruction. This method and system of updating the FSR passes the abort code with the instruction through the pipeline to the execute stage where the FSR is updated.

### TECHNICAL FIELD

The present disclosure is generally related to computer processors and, more particularly, is related to an improved system and method for updating an instruction fault status register in a computer processor.

### BACKGROUND

Processors (e.g., microprocessors) running code are well known and used in a wide variety of products and applications, from desktop computers to portable electronic devices, such as cellular phones and PDAs (personal digital assistants).

There are many architectures used to process instructions in a processor. Each architecture handles problems or faults introduced in the code it is running in different ways. An important feature of each of the architectures is how the problem, or fault, is reported and handled. The terms “fault” and “abort” are used interchangeably in this disclosure.

In a non-limiting example, in a three stage pipeline architecture, as in many processor architectures, when a code instruction is fetched, if a fault is detected, a Fault Status Register (FSR) will be updated with information indicating the type of fault that has been detected. However, the processor does not immediately take any action with respects to the associated instruction while it is in the fetch stage. Instead, the instruction moves to the next stage, the decode stage, and then on to the next subsequent stage, the execute stage. It is not until the execute stage that the fault is actually acknowledged by the processor and the processor vectors to an abort handler to handle the fault. In this particular implementation, it will take at least three clock cycles before the fault is acknowledged. As a result, prior to the instruction and its fault being executed and acknowledged, two more instructions may be fetched by the fetch stage of the processor.

This can be better understood by examining fault handling in a pipeline architecture in more detail. A first instruction is fetched and a fault is detected. The cause of the fault is recorded in the instruction FSR. When the first instruction moves to the decode stage of the processor's pipeline, a second instruction is fetched and a fault may also be detected in association with this second instruction fetch. If this occurs then the cause of the second instruction's fault will be recorded in the FSR, overwriting the fault status information associated with the first instruction. Aborts can occur sequentially; but usually they are for the same reason. In these instances, successive faults are not problematic. Subsequently, the first instruction will move to the execute stage, the second instruction will move to the decode stage and a third instruction will be fetched. When the first instruction is executed in the execute stage, the abort will be recognized and cause the processor to vector to its abort handler. Once in the abort handler the processor will read its instruction FSR to determine the cause of the fault associated with the first instruction; the fault cause will determine what actions the processor will take to resolve the associated problem. Thus it is important that the cause of the associated fault is correct, otherwise the processor may not take the proper corrective actions.

In some instances, however, there are problems when waiting until the execute stage to handle aborts. For example, if two instructions are fetched, the first may abort for reason A, and the second may abort for a different reason B. When the first instruction moves to the decode stage, the second instruction is fetched and updates the instruction FSR with the reason for its abort, reason B. Then when the first instruction moves to the execute stage, it will cause the processor to vector to the abort handler, which may read the instruction FSR and the wrong abort reason (reason B instead of reason A) will be read from the FSR.

Since the abort reason in the FSR cannot be relied upon, a more complicated abort handler routine is necessary to determine the cause of the fault. This makes supporting more sophisticated memory management operating systems more complicated and reduces their performance. A memory management operating system uses the concept of virtual memory in its operation. A virtual memory implementation is used in situations where a user has a small amount of physical memory, but the user wants to force the software code to run as if there is more memory. This virtual memory is achieved through the operating system (OS). When the software tries to access memory that is not really there, the virtual memory, a fault will be detected and the process interrupted by subsequently vectoring to the abort handler as described previously. In the abort handler, the OS may manipulate the memory by transferring information between a hard drive, for example, and the physical memory available. The code is then restarted at the point that it was interrupted. The memory location that the code is addressing now appears to be present.

For example, a first Linux operating system (a master OS) may be running the PC that is in control of the hardware and that keeps track of the actual configuration of the hardware. But a user can boot a second version of Linux within that master Linux operating system such that it thinks it controls all the hardware when it really does not. The master Linux operating system is controlling it. Then a user can, in parallel, boot Windows XP. A user can also boot Windows 98. So under the first Linux operating system, there may be three other operating systems that each operate as if it is in complete control of the display, the hard disk drive, etc. But, in reality, each has no control at all. The master OS asserts control for them. Although there may be a performance penalty, this implementation allows a user who runs most applications in Linux, because it is more expedient or because most of the applications the user wants to run are only available on Linux, to bring Windows up under a Linux master OS to run some application that is only available in Windows. It also allows a user to bring up multiple versions of Linux when, even though the user may not need each version all the time, one version has advantages over another.

An operating system must know which instruction was interrupted and why it was interrupted. In prior art systems, this information may not be accessible. In this regard, prior art systems determine and set a reason for a fault at the fetch stage. If faults are encountered in successive instructions, then the value stored in the fault status register is no longer reliable when the first faulted instruction reaches the executed stage. That is, if another abort has occurred for a different reason, during the progression from the fetch stage to the execute stage, the operating system may not be able to determine the cause of the abort from the FSR and will have to determine the cause of the fault by manually reading the associated memory management page tables. This manual reading of the associated memory management tables adds complexity to the OS and consumes more processor time. As a result, what is desired is an implementation whereby the OS may always rely on the validity of the information it reads from the FSR, which in turn will reduce the complexity of the OS needed and improve processor performance.

### SUMMARY OF THE DISCLOSURE

Embodiments of the present disclosure provide improved systems and methods for updating an instruction fault status register so that accurate fault information is provided to an execute unit, even if multiple, successive faults are encountered.

Briefly described, in architecture, one embodiment of the system, among others, can be implemented as follows. A system for updating an instruction fault status register with a fetching stage; a decoding stage communicatively coupled to the fetching stage; an executing stage communicatively coupled to the decoding stage; a Memory Management Unit or Protection Unit (MMU/PU) for determining a fault in an instruction, the MMU/PU communicatively coupled to the fetching stage; fault communication logic communicatively coupled to the MMU/PU; and an instruction fault status register communicatively coupled to the fault communication logic.

One embodiment of such a method, among others, can be broadly summarized by the following steps: fetching an instruction; determining if the instruction is faulty;

decoding the instruction; and executing the instruction, wherein, if the instruction is faulty an indication that the instruction is faulty and the reason it is faulty is passed with the instruction to the decoded and execute stages.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a pipelined processor architecture as known in the prior art.

FIG. 2 is a block diagram of three sequential instructions with aborts.

FIG. 3 is a block diagram of a pipelined processor architecture in accordance with one embodiment of the present invention.

FIG. 4 is a block diagram of a pipelined processor architecture in accordance with an exemplary embodiment of the present invention.

FIG. 5 is a block diagram of a pipelined processor architecture in accordance with an alternative embodiment of the present invention.

FIG. 6 is a flowchart of an exemplary embodiment of a method for updating an instruction fault status register in a pipelined processor.

### DETAILED DESCRIPTION

Disclosed herein are systems and methods for updating a fault status register in a pipelined processor. To facilitate description of the inventive systems, an example system that can be used to implement the systems and methods for updating a fault status register is discussed with reference to the figures. Although this system is described in detail, it will be appreciated that this system is provided for purposes of illustration only and modifications are feasible without departing from the inventive concept.

Referring now and in more detail to the drawings in which like numerals indicate corresponding parts through the several views, this disclosure describes a system for updating a fault status. It describes how the system is configured and how it operates.

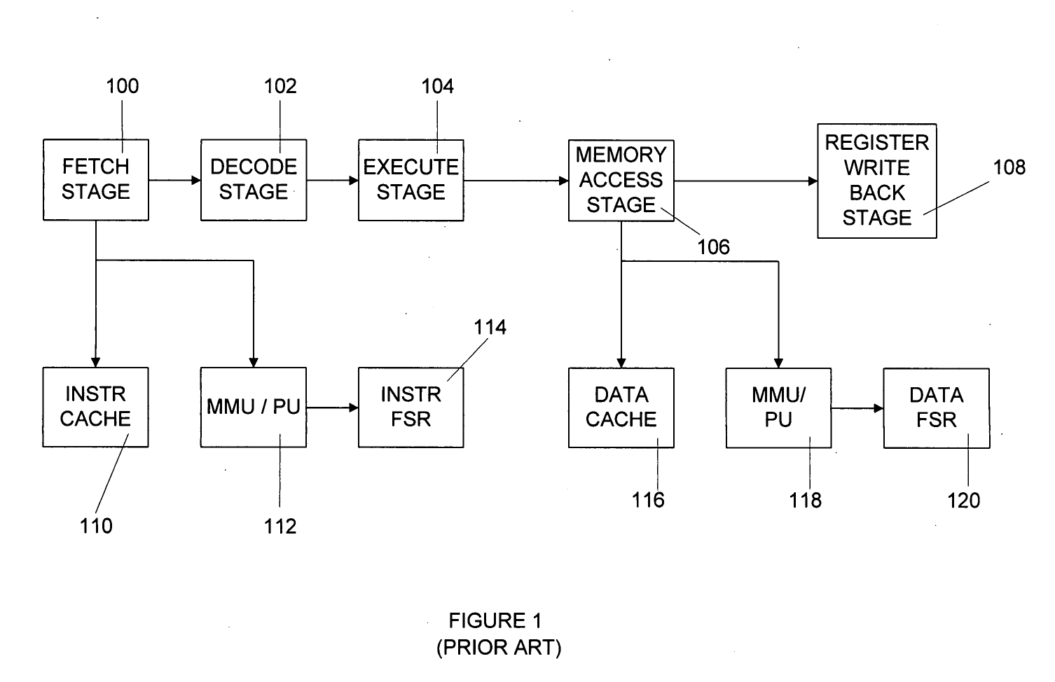

As shown in the block diagram of FIG. 1, within a pipelined processor, there are a variety of functional stages, including, among others, a fetch stage 100, a decode stage 102, and an execute stage 104. As is known, the decoder logic of a processor decodes an encoded instruction into a number electrical signals for controlling and carrying out the function of the instruction within execution logic provided on the processor.

At a very high level, the fetch/execute portion of a processor includes fetch logic 100 for fetching an encoded instruction and decoder logic 102 for decoding the instruction. As mentioned above, the decoder 102 operates to decode an encoded instruction into a plurality of signal lines, which are used to control and carry out the execution of the encoded instruction. In this regard, the outputs from the decoder 102 are signal lines that are used as inputs and/or control signals for other circuit components within an execution unit (not shown) of the processor, and the execution unit carries out the functional operations specified by the encoded instructions. This basic operation is well known, and need not be described further herein.

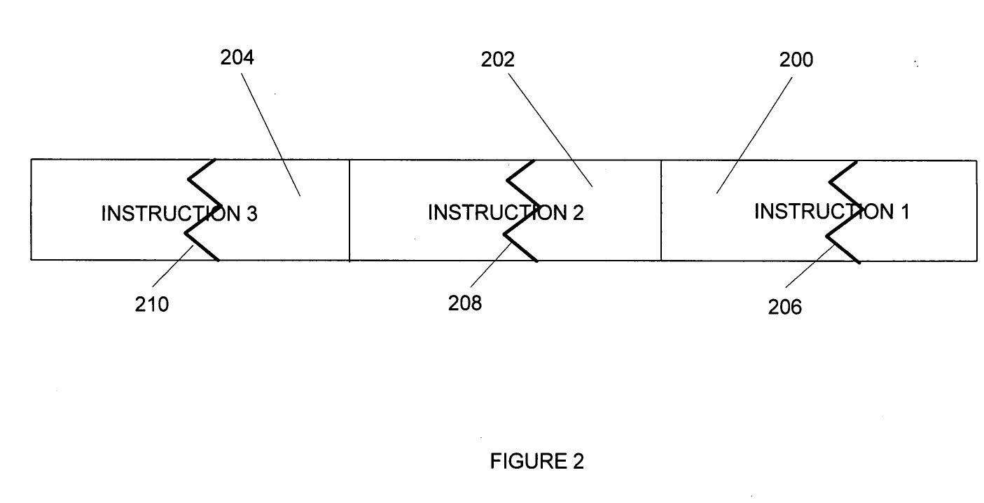

In the exemplary embodiment illustrated in FIG. 2, the pipeline may be designed to accommodate both a 32-bit instruction set as well as a 16-bit instruction set. Multiple instruction sets, such as these may be provided for flexibility in programming, accommodation of legacy software, or other reasons. Generally speaking, 32-bit instruction sets may provide more powerful or robust code and programming capabilities, while 16-bit instruction sets provide for more compact code, which requires less memory. As will be appreciated by persons skilled in the art, other advantages or tradeoffs between 32-bit instruction sets and 16-bit instruction sets may be applicable as well. It will be appreciated by persons skilled in the art that there are a variety of ways to specifically implement the concepts illustrated in the diagram of FIG. 2, and the broader aspects of the present invention are not limited by any particular implementation.

As provided above, the fault status register, FSR, provides an indicator of the type of abort or fault that has occurred in an instruction. The term “abort” and “fault” are used interchangeably in this disclosure. Based on the information concerning the abort in the FSR, a correcting action can be performed.

There are several reasons that an abort can occur. Non-limiting examples include table aborts in memory and external aborts through hardware. There can be MMU first page aborts, and second page aborts among others. An abort may occur because the application is trying to access a memory address that is not valid. There may be an external bus abort. There may be an abort because parity does not match.

There may also be an abort because the system is a virtual memory system and the memory image being accessed is not mapped in memory, but it may exist. It may presently be on the hard disk drive.

In the prior art, as provided in FIG. 1, there are three main instruction stages: the fetch stage 100, the decode stage 102, and the execute stage 104. The MMU/PU 112 identifies instruction memory management/protection faults and aborts. When the instruction is fetched, if a fault is detected by the MMU/PU 112, the FSR 114 is updated immediately. But the fault is not acknowledged at this time. The currently executing code does not get interrupted. Then the instruction moves to the next stage, the decode stage 102. It is only when the instruction gets to the execute stage 104 that the abort is actually acknowledged by the processor and the processor vectors to the abort handler. It takes a minimum of three clock cycles, and maybe more depending on the structure of the pipeline, before the abort is acknowledged. The remaining section of the pipeline includes blocks 106, 108, 116, 118, and 120, which do not directly effect the handling of instruction faults, and are provided to illustrate a complete processor pipeline. System block 106 is a memory access stage. System block 108 is a register write back stage. System block 116 is a data cache. System block 118 is a data memory management/protection unit. System block 120 is a data FSR.

FIG. 2 depicts three consecutive instructions 200, 202, 204. A problem occurs when there are different causes for the aborts 206, 208, and 210 within the three instructions 200, 202, 204. The first instruction 200 causes an abort 206 and sets the reason code in the FSR 114. The next instruction 202 causes an abort 208, but for a different reason. As a non-limiting example, if these two instructions 200 and 202 cross a page boundary, then they could abort for completely different reasons. In this example, there are three instructions in a row. There is a page boundary in instruction 202. Instruction 200 has a page fault. It is fetched and the FSR is updated. Instruction 200 is decoded and instruction 202 is fetched. There is fault 208 in instruction 202. Each instruction then moves one more stage down the pipeline. A third instruction 204 is fetched with abort 210, and the FSR is again updated. As instruction 200 reaches the execute stage, the processor vectors to the abort handler with the contents of the FSR corresponding to abort 210 from instruction 204. As a result, the abort handler cannot rely on the contents of the instruction FSR 114 and must perform a more complex and time consuming software routine to determine the cause of the abort prior to proceeding to the appropriate recovery routine.

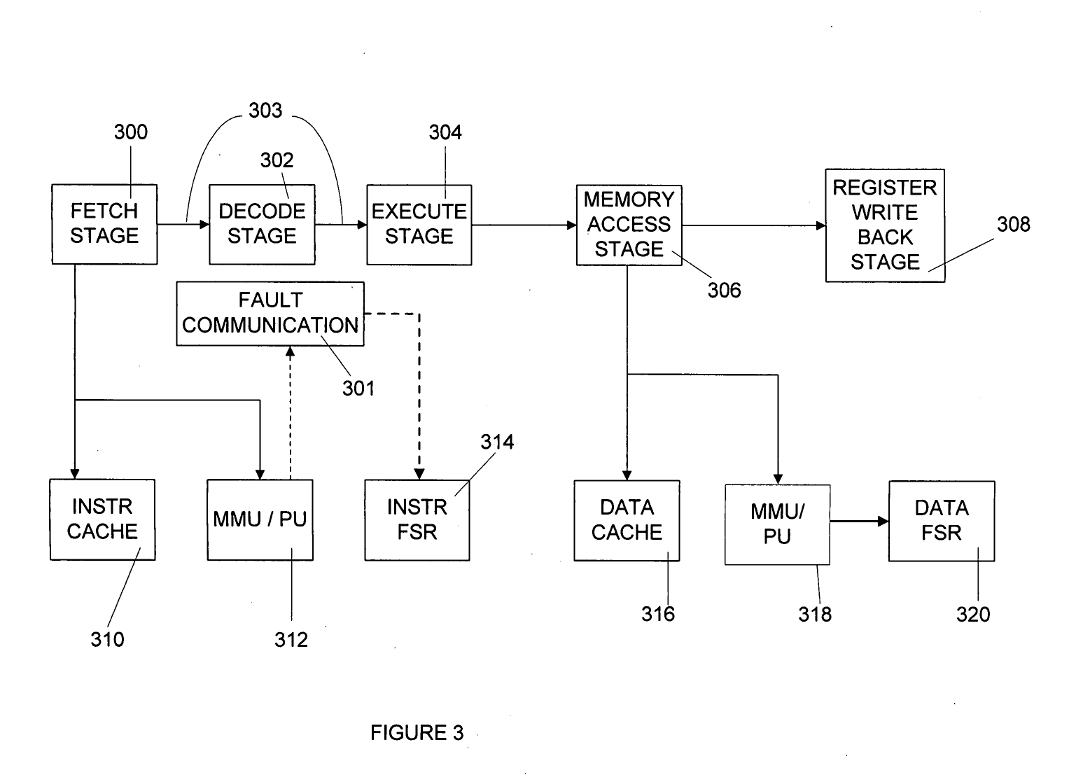

To solve this problem, in FIG. 3 logic for effectively communicating identification of a fault to the execute stage is introduced into the pipeline architecture of FIG. 1. The FSR 314 is not updated until the instruction reaches the execute stage 304. The information that the FSR 314 needs is in the MMU/PU 312. The MMU/PU 312 identifies instruction memory management/protection faults and aborts. The currently executing code does not get interrupted when the instruction first appears in fetch stage 300. The instruction then moves from the fetch stage 300 to the decode stage 302 and then subsequently to the execute stage 304 along bus lines 303. It is only when the instruction reaches execute stage 304 that fault communication block 301 updates the instruction FSR 314, the abort causes the processor to vector to an abort handler. It takes a minimum of three clock cycles, and maybe more depending on the structure of the pipeline, before the abort is acknowledged. The remaining section of the pipeline includes blocks 306, 308, 316, 318, and 320, which do not directly effect the handling of instruction faults, and are provided to illustrate a complete processor pipeline. System block 306 is a memory access stage. System block 308 is a register write back stage. System block 316 is a data cache. System block 318 is a data memory management/protection unit. System block 320 is a data FSR.

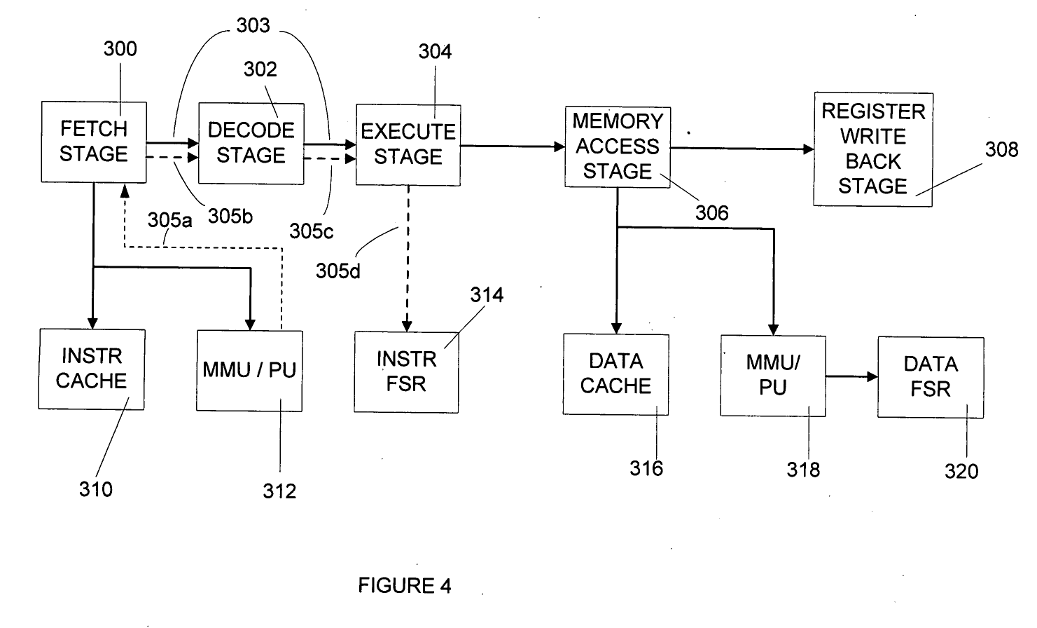

In FIG. 4, an exemplary embodiment of the fault communication logic is provided. The information concerning the abort as determined by MMU/PU 312 is passed along with the instruction from the fetch stage 300 to the decode stage 302 and on to the execute stage 304. Signal bus 305a carries the fault information from the MMU/PU 312 to fetch stage 300. Signal bus 305b carries the fault information from the fetch stage 300 to decode stage 302 as the instruction is passed from the fetch stage 300 to decode stage 302. Signal bus 305c carries the fault information from the decode stage 302 to execute stage 304 as the instruction is passed from the decode stage 302 to the execute stage 304. Signal bus 305d carries the fault information from the execute stage 304 to instruction FSR 314. Alternatively, the fault information may be transferred from decode stage 302 directly to the instruction FSR 314 when the instruction is passed from the decode stage 302 to the execute stage 304. Signal bus 305a-d may be one or more lines. The instruction FSR is not updated at the first stage. Instead, the instruction FSR is updated when the instruction reaches execute stage 304.

Referring to the example as shown in FIG. 2, in an exemplary embodiment, there are three consecutive instructions 200, 202, 204. A problem occurs when there are different aborts 206, 208, and 210 within three instructions 200, 202, 204. The first instruction 200 causes an abort, but in the exemplary embodiment, the reason code is not yet set in FSR 314. The next instruction 202 causes an abort 208, but for a different reason. As a non-limiting example, if these two instructions 200 and 202 cross a page boundary, then they could abort for completely different reasons. In this example, there are three instructions in a row. There is a page boundary in instruction 202. Instruction 200 has a page fault. Instruction 200 is decoded and instruction 202 is fetched. There is fault 208 in instruction 202. Each instruction then moves one more stage down the pipeline. A third instruction 204 is fetched with abort 210. As instruction 200 reaches the execute stage, the abort handler is called with the contents of the FSR which has now been updated with abort 206 from instruction 200. Even though all three may have aborted for their own various reason codes, in the exemplary embodiment, that abort information follows the instruction through the pipeline no matter how deep the pipeline is.

So, the instruction is not passed through the pipeline alone. The decode stage actually passes much more. An exemplary embodiment passes the bits corresponding to the reason for the abort along with the instruction and loads them in the instruction FSR 314 when the abort is acknowledged at the execute stage 304. When the abort handler is called, it is passed the abort reason for the instruction currently in the execute stage. In this exemplary embodiment, since the abort reason is passed along with the instruction, the abort handler may rely on the validity of the abort reason recorded in the instruction FSR 314. As a result the abort handler may be simplified, allowing it to be performed more efficiently.

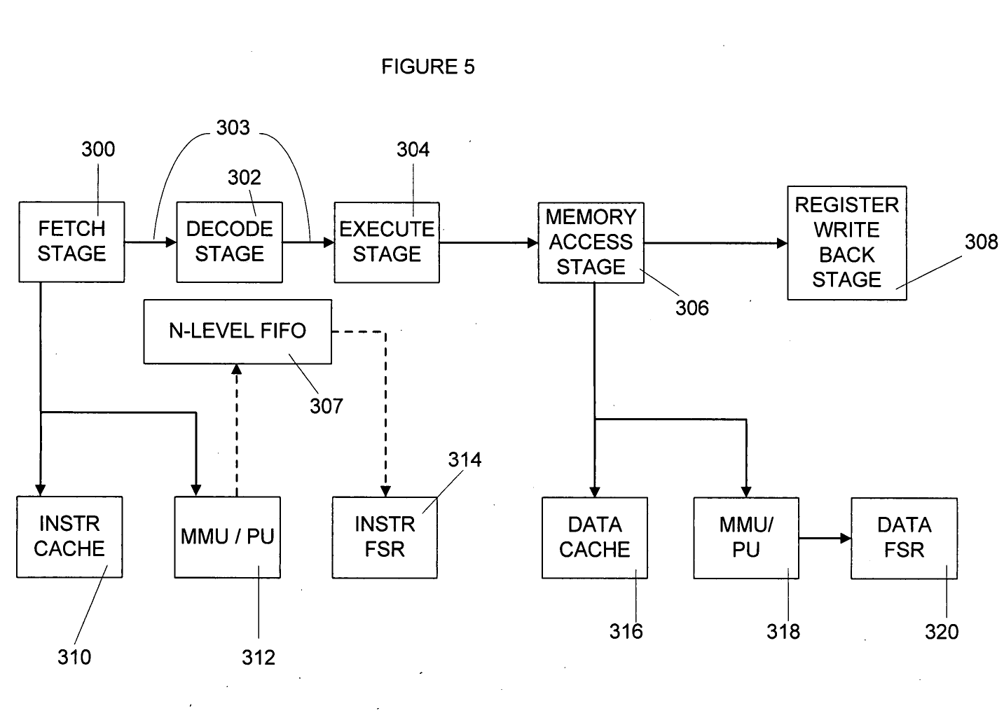

Another alternative embodiment of fault communication logic 301 is provided in FIG. 5. An n-level FIFO 307 is used to store the fault information to load into instruction FSR 314 when the instruction reaches execute stage 304. The depth of the FIFO 307 should be at least as large as the depth of the instruction pipeline. An exemplary embodiment of the pipeline architecture has three stages, so the FIFO 307 should be at least a three level FIFO. However, the pipeline may be longer or shorter, so the FIFO could be changed accordingly.

An alternative embodiment combines the FIFO 307 and instruction FSR 314. The FSR 314 is an actual FIFO in this example. Whenever a fault occurs, the MMU/PU 312 loads the fault information into the FSR/FIFO 314/307. When the instruction reaches the execute stage 304, the fault information is retrieved from the FSR/FIFO 314/307. Since the fault information is loaded into the FIFO stack, any previous fault is not overwritten and the abort handler processes the appropriate fault information.

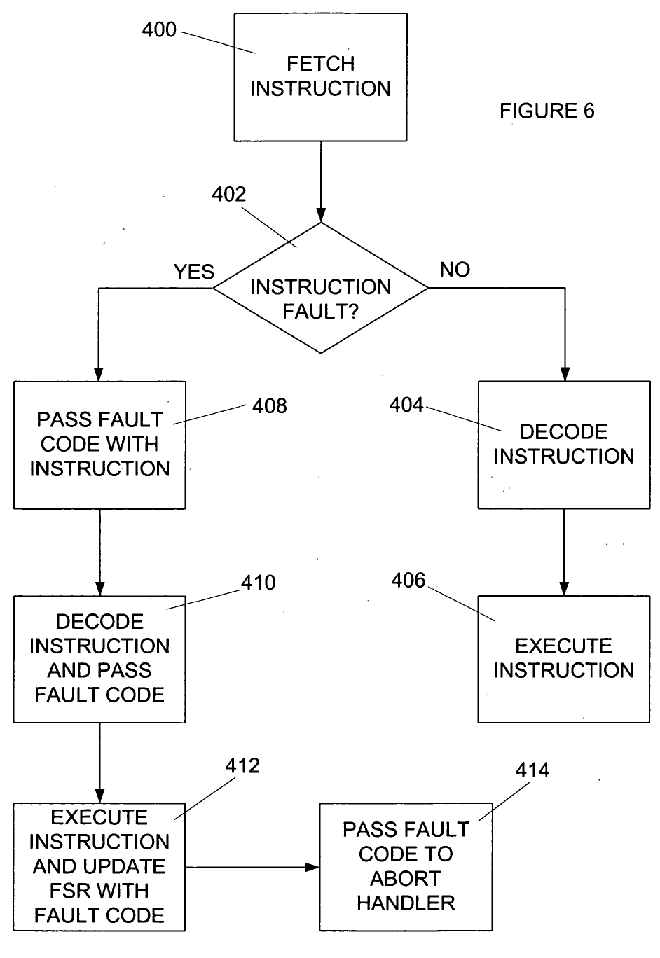

Having described certain features and architectural implementations of certain embodiments of the present invention, reference is now made to FIG. 6, which provides a flowchart for the progression of an instruction through the pipeline. The instruction is fetched in step 400. After the instruction is fetched, a determination is made as to whether there is a fault in the instruction at step 402. This determination is performed by MMU/PU 312. If no fault is determined to be present in the instruction at step 402, the instruction is decoded at step 404 and executed at step 406. However, if a fault is determined to be present by MMU/PU 312 in step 402, the fault code is passed along with the instruction down the pipeline to the decode stage in step 408. At the decode stage, the instruction is decoded and the fault code is passed with the decoded instruction to the execute stage in step 410. At step 412, the instruction FSR is updated with the fault code corresponding to the fault of the instruction currently in the execute stage and the instruction is executed. An abort handler is called in step 414 and the fault code is passed to the abort handler.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, having thus described the disclosure, the following is claimed:

1. A system for updating an instruction fault status register in a processor pipeline comprising:
a processor pipeline with at least three stages for processing an instruction;
a fault determination block communicatively coupled to the fetching stage of the processor pipeline;
fault communication logic communicatively coupled to the fault determination block; and
an instruction fault status register communicatively coupled to the fault communication logic.

2. The system of claim 1,
wherein the fault communication logic comprises a signal bus to pass fault information with the instruction to an executing stage in the processor pipeline.

3. The system of claim 1,
wherein the instruction fault status register is updated by the fault communication logic corresponding to fault information associated within an instruction.

4. The system of claim 1, wherein the processor pipeline will vector to an abort handler in response to executing an instruction with an abort.

5. The system of claim 4, wherein the contents of the instruction fault status register are passed to the abort handler.

6. The system of claim 1,
wherein the fault communication logic comprises a FIFO.

7. The system of claim 6,
wherein the depth of the FIFO corresponds to the number of stages for processing an instruction.

8. The system of claim 1,
wherein the fault communication logic and the instruction fault status register are integrated into a FIFO.

9. A method of updating an instruction fault status register comprising:
fetching an instruction;
determining if the instruction is faulty;
decoding the instruction; and
executing the instruction;
wherein if the instruction is faulty, an indication that the instruction is faulty and the reason it is faulty is passed with the instruction to at least a decode stage and an execute stage of a pipelined processor.

10. The method of claim 9, further comprising:
updating an instruction fault status register with abort information corresponding to the execution of any instruction that is aborted.

11. The method of claim 10, further comprising:
providing the contents of the instruction fault status register to an abort handler.

12. A processor with a system for updating an instruction fault status register in a processor pipeline comprising:
a fetching stage;
a decoding stage communicatively coupled to the fetching stage;
an executing stage communicatively coupled to the decoding stage; and
an MMU/PU for determining a fault in an instruction, the MMU/PU communicatively coupled to the fetching stage;
fault communication logic communicatively coupled to the MMU/PU; and
an instruction fault status register communicatively coupled to the fault communication logic.

13. The processor of claim 12,
wherein the fault communication logic comprises a signal bus to pass fault information with the instruction to the executing stage.

14. The processor of claim 12,
wherein the instruction fault status register is updated corresponding to fault information associated with an instruction.

15. The processor of claim 12, wherein the processor pipeline will vector to an abort handler in response to executing an instruction with an abort.

16. The processor of claim 15, wherein the contents of the instruction fault status register are passed to the abort handler.

17. The processor of claim 12,
wherein the fault communication logic comprises a FIFO.

18. The processor of claim 17,
wherein the depth of the FIFO corresponds to a number of stages in an instruction pipeline.

19. The processor of claim 12,
wherein the fault communication logic and the instruction fault status register are integrated into a FIFO.
